(19) United States
(12) Patent Application Publication
(10) Pub. No.: US 2026/0311041 A1
(43) Pub. Date: Oct. 8, 2026

(54) BLOCKCHAIN-SMART-CONTRACT-DRIVEN DECENTRALIZED AI TRAINING DATA COLLECTING AND LABELING METHOD

(71) Applicant: METABLOCK HOLDINGS LTD, Majuro (MH)

(72) Inventor: Qin Wang, Shenzhen (CN)

(21) Appl. No.: 19/172,845

(22) Filed: Apr. 8, 2025

Related U.S. Application Data
(63) Continuation of application No. PCT/CN2024/121288, filed on Sep. 26, 2024.

(51) Int. Cl. G06N 20/00; G06Q 10/0631; G06Q 40/03

(52) U.S. Cl. CPC G06N 20/00; G06Q 10/063112; G06Q 40/03

(57) ABSTRACT

A blockchain-smart-contract-driven decentralized AI training data collecting and labeling method includes: deploying a decentralized workflow engine (DWE) to the target blockchain (S1), configuring roles and permissions (S2), creating tasks and escrowing funds by the publisher based on role permissions (S3), automatic task splitting and allocation by the system (S4), task acceptance and completion by workers (S5), review by verifiers and reaching data consistency through a BFT consensus algorithm (S6), automatic payment execution by the system (S7), and updating user credit scores based on performance (S8). The present disclosure uses a BFT consensus algorithm and DWE, combined with a distributed task allocation mechanism and AI-assisted verification tools, to eliminate intermediary links, reduce transaction costs, improve work efficiency, and ensure data quality, solving the problems of high cost, low efficiency, and poor quality control in traditional methods.

### CROSS-REFERENCE TO RELATED APPLICATIONS

This application is a Continuation Application of PCT application PCT/CN2024/121288, filed on 2024 Sep. 26, entitled “Blockchain-Smart-Contract-Driven Decentralized AI training data Collecting and Labeling Method”, the entire contents of which are incorporated herein by reference.

### TECHNICAL FIELD

The present disclosure relates to blockchain technologies, specifically to a blockchain-smart-contract-driven decentralized AI training data collecting and labeling method.

### BACKGROUND

Existing AI training data collecting and labeling platforms generally suffer from high cost, low quality, and low efficiency. These platforms usually depend on intermediary service providers for data collecting and labeling, which results in high service charges that reduce final rewards and restrict the scale and efficiency of data collecting and labeling. The traditional financial payment system also limits the effective use of the global workforce and increases the complexity of payment rewards. In addition, these platforms have a single quality control method and lack a flexible and efficient review mechanism to ensure the quality of data collecting and labeling.

As can be seen from the above, notable technical problems are the rising cost of existing platforms due to high intermediary fees and data quality issues due to the lack of effective quality control mechanisms.

### SUMMARY

The present disclosure aims to provide a blockchain-smart-contract-driven decentralized AI training data collecting and labeling method, aiming to reduce transaction costs and improve efficiency by eliminating intermediate links, and to ensure data consistency and quality through the BFT data consensus algorithm, so as to solve the problems raised in the above background technology.

To achieve the above purpose, the present disclosure adopts the following technical solution: a blockchain-smart-contract-driven decentralized AI training data collecting and labeling method, which includes the following steps: S1: Deploying a decentralized workflow engine to a target blockchain, the workflow engine being used to manage distribution and validation of tasks; S2: Configuring roles and permissions based on the workflow engine deployed in S1, including but not limited to permissions of workers, verifiers, reviewers, and publishers; S3: Publishers creating tasks according to the role permissions configured in S2, uploading original datasets to be collected and labeled, setting requirements of collecting and labeling, and escrowing corresponding funds through a smart contract; S4: A system automatically splitting the original datasets into multiple small tasks according to the tasks created in S3 and allocating the multiple small tasks to suitable workers based on the role configuration in S2; S5: Workers accepting tasks and performing data collecting and labeling according to the tasks allocated in S4; S6: Verifiers reviewing the collecting and labeling results submitted by workers in S5 and reaching data consistency through a BFT consensus algorithm; S7: The system automatically executing a payment process through the smart contract based on the data consistency reached in S6; S8: Updating users' credit scores based on the performance of workers from S5 to S7.

Preferably, the deployment of the workflow engine in S1 includes establishing network, workflow, and blockchain layers, which communicate and coordinate with each other.

Preferably, the role and permission configuration in S2 includes permission management via RBAC.

Preferably, when publishers create tasks in S3, they also set task types, detailed task descriptions, collecting/labeling specifications, and reward and incentive mechanism parameters.

Preferably, the automatic task splitting and allocation in S4 also include data analysis and preprocessing, intelligent task splitting, and generation of unique task IDs.

Preferably, when workers perform tasks in S5, they also use AI-assisted collecting and labeling tools.

Preferably, the verification and review in S6 also includes cross-verification and voting by multiple verifiers to reach BFT consensus and random spot checks.

Preferably, the payment and settlement in S7 includes supporting cryptocurrency and fiat payments and enabling inter-blockchain payments through cross-chain bridges.

Technical effects and advantages: Compared with existing technologies, the provided in the present disclosure has the following advantages:

The present disclosure reduces transaction costs by eliminating intermediary links, improves work efficiency, and ensures data consistency and quality through a BFT data consensus algorithm by using a BFT data consensus algorithm and a decentralized workflow engine (DWE), combined with a distributed task allocation mechanism and AI-assisted collection, labeling, and verification tools. This method not only enhances the overall efficiency of data collecting and labeling but also simplifies the reward payment process, especially payment via cryptocurrency through the automated payment process of smart contracts, thereby solving the problems of high cost, low efficiency, and poor quality control in existing technologies during data collecting and labeling.

### BRIEF DESCRIPTION OF DRAWINGS

To more clearly illustrate the technical solutions in the present disclosure or prior art, a brief description of the accompanying drawing to be used in the description of the embodiments or prior art will be given below. The drawing described below is obviously just an embodiment of the present disclosure. For ordinary technicians in this field, other drawings can be obtained based on the drawing without doing creative work.

FIG. 1 is a flowchart of the blockchain-smart-contract-driven decentralized AI training data collecting and labeling method of the present disclosure.

FIG. 2 is a server-side architecture diagram of the present disclosure.

FIG. 3 is a DWE system architecture diagram of the present disclosure.

FIG. 4 is a verification and review process diagram of the present disclosure.

### DESCRIPTION OF EMBODIMENTS

The technical solutions in the embodiments of the present disclosure are clearly and completely described below in combination with the specific contents of the present disclosure. Obviously, the described embodiments are only a part of the embodiments of the present disclosure, rather than all the embodiments. Based on the embodiments of the present disclosure, all other embodiments obtained by ordinary technicians in the field without making any creative work shall fall within the protection scope of the present disclosure. The contents not described in detail in the embodiments of the present disclosure belong to the prior art known to professional and technical personnel in the field.

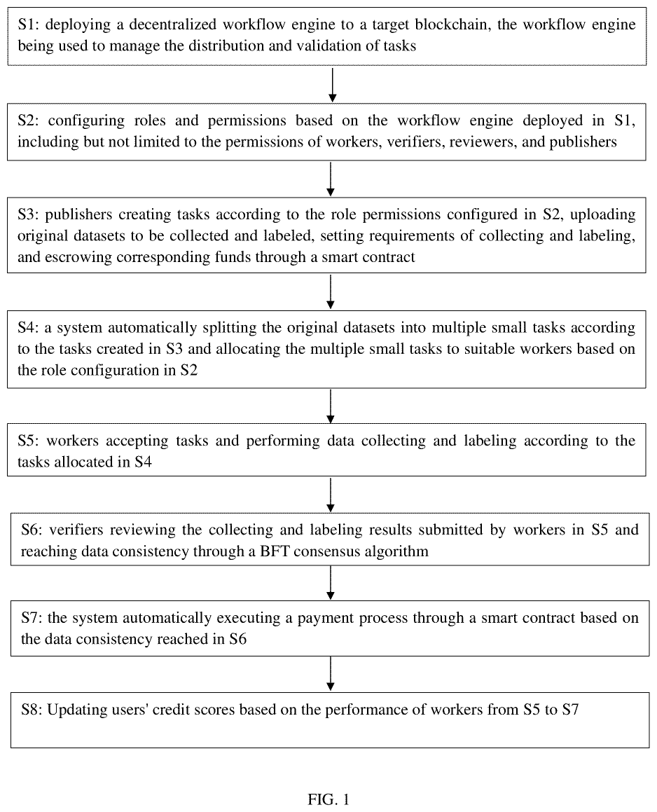

The present disclosure provides a blockchain-smart-contract-driven decentralized AI training data collecting and labeling method. As shown in FIG. 1, it includes the following steps:
S1: Deploying a decentralized workflow engine to a target blockchain, the workflow engine being used to manage distribution and validation of tasks.

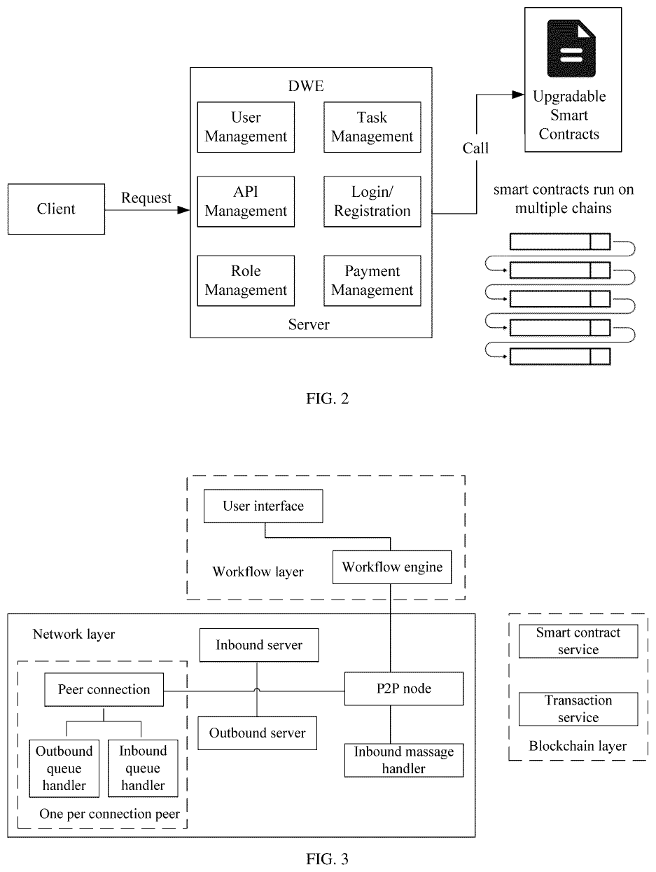

Specifically, as shown in FIG. 2, the server-side includes a workflow engine (DWE), which is responsible for managing and scheduling different functional components, such as user management, task management, API management, login/registration, role management, and payment management. The client sends requests to the server to call these services.

On the server-side, there are various sub-modules within the DWE module, each corresponding to different functions, such as User Management, Task Management, API Management, Login/Registration, Role Management and Payment Management. The client then sends requests to the server to invoke these services.

On the server-side, there are various sub-modules within the DWE module which correspond to different functions:
User Management: Handles user-related operations, such as account information maintenance and identity authentication.
Task Management: Allocates, tracks, and monitors tasks to ensure they are executed smoothly according to the predetermined process.
API Management: Provides application programming interfaces (APIs) to allow external programs or services to interact with the system.
Login/Registration: Manages the user login and registration process to ensure security and accessibility.
Role Management: Defines and manages different types of user roles for permission control and access strategies.
Payment Management: Handles payment-related matters, including payments, especially payment via cryptocurrency and refunds.

In the interaction between the server and the client, the client can call these services through requests. The smart contracts on the server run on multiple chains, meaning they can be executed across different blockchain networks, providing greater flexibility and interoperability.

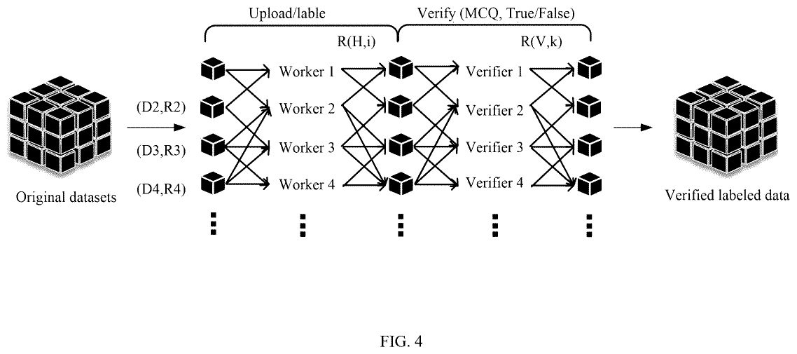

Further, as shown in FIG. 3, the deployment of the workflow engine includes establishing network, workflow, and blockchain layers, which communicate and coordinate with each other.

Network Layer: Composed of multiple nodes and connections, it mainly handles communication between nodes. Each peer connection is responsible for communication with other nodes and manages message transmission and reception through outbound and inbound queue processors. Peer Connection: Each node's connection is responsible for communication and data exchange, ensuring the effective transmission of network messages. Outbound Server & Inbound Server: Handle information sending and reception. The outbound server sends information to other nodes, and the inbound server receives and processes information from external nodes. P2P Node: Handles messages from other nodes and distributes them to relevant inbound message processors. This module is also responsible for interacting with the blockchain layer.

Workflow Layer: Composed of the workflow engine and the task list user interface (UI). The workflow engine is the core component for task allocation and scheduling, while the UI provides users with a visual display and interaction function for task status. Worklist UI: Provides a graphical user interface where users can view the current list of tasks, task status, and interact with the workflow engine. Workflow Engine: The core component that manages and schedules tasks. According to the system-set rules and task requirements, it allocates tasks to suitable workers and tracks the progress of task execution in real time.

Blockchain Layer: Mainly responsible for on-chain recording of tasks and transactions and interaction with smart contracts. It ensures that important steps in task execution are recorded on the blockchain, guaranteeing transparency and immutability. Transaction Service: Manages transactions related to tasks, ensuring that each task execution can be recorded on the chain to guarantee transparency. Smart Contract Service: Automatically executes task rules through smart contracts, ensuring that tasks on the platform are processed according to the predetermined logic.
S2: Configuring roles and permissions based on the workflow engine deployed in S1, including but not limited to permissions of workers, verifiers, reviewers, and publishers. Further, the role and permission configuration includes permission management via RBAC to ensure the security and effectiveness of task allocation and execution.
S3: Publishers creating tasks according to the role permissions configured in S2, uploading original datasets to be collected and labeled, setting requirements of collecting and labeling, and escrowing corresponding funds through a smart contract. Further, in this process, publishers need to set the following specific parameters:

Task Type Selection: Clearly specify whether the task is data collection, data labeling, or both, so the system can handle it accordingly.

Detailed Task Description: Provide specific task requirements, including data format, quality standards, quantity requirements, and completion deadlines.

Collection/Labeling Specifications: Upload or link to detailed operation guides to instruct workers on how to correctly perform tasks.

Reward and Incentive Mechanism: Set the basic reward for each sub-task and additional incentive conditions, such as early completion or high-quality delivery.

Fund Escrow Submission: Based on the task scale and reward standards, escrow a corresponding amount of cryptocurrency to the system through a smart contract to ensure fund security and transparency.
S4: A system automatically splitting the original datasets into multiple small tasks according to the tasks created in S3 and allocating the multiple small tasks to suitable workers based on the role configuration in S2. Further, task automatic splitting and allocation also include data analysis and preprocessing, intelligent task splitting, and generation of unique task IDs for tracking and management. The specific splitting process is as follows:

Data Analysis and Preprocessing: Parse the uploaded dataset to determine the smallest task unit that can be split (such as an image, audio clip, text segment, video clip, etc.).

Intelligent Task Splitting: Generate a globally unique task ID (UUID) for each small task to facilitate subsequent tracking and management. Select the most suitable workers using recommendation algorithms (different strategies such as collaborative filtering or machine learning models) based on workers' skill tags, historical performance, and credit scores.
S5: Workers accepting tasks and performing data collecting and labeling according to the tasks allocated in S4. Further, when workers perform tasks in S5, they also use AI-assisted collecting and labeling tools. Specifically, the process of workers performing tasks is as follows:

Worker Task Acceptance: Workers view and accept tasks assigned to them on the platform, read task requirements and collection/labeling guidelines.

Data Collecting and labeling Process: Workers use the AI-assisted collecting and labeling tools provided by the platform to collect and label data according to task requirements. After completing the collecting and labeling, they submit the results to the platform.
S6: Verifiers reviewing the collecting and labeling results submitted by workers in S5 and reaching data consistency through a BFT consensus algorithm. Further, verification and the review also include cross-verification and voting by multiple verifiers to reach BFT consensus and random spot checks.

Specifically, as shown in FIG. 4, the verification and review process is as follows:

Verifier Review of Collecting and labeling Results: Verifiers receive the collecting and labeling results submitted by workers and review them according to the task's quality standards to confirm the accuracy and consistency of the collecting and labeling.

Achieving Data BFT Consensus: Multiple verifiers cross-verify and vote on the same data package on the blockchain to reach BFT consensus for individual data items. The voting and consensus results are either passed or rejected.

Reviewer Spot Checks: Reviewers randomly spot-check some of the verified collecting and labeling results to ensure overall collecting and labeling quality. For any issues found, they provide feedback to verifiers and workers, and adjust their credit scores when necessary.
S7: The system automatically executing a payment process through the smart contract based on the data consistency reached in S6. Further, the payment and settlement includes supporting cryptocurrency and fiat payments and enabling inter-blockchain payments through cross-chain bridges.

Specifically, when the collecting and labeling results pass verification and review, the smart contract automatically triggers the payment process. Rewards are distributed to workers and verifiers according to the pre-set distribution ratio. The platform supports both cryptocurrency and fiat payments. Through cross-chain bridges, the platform enables payment settlements across different blockchains, ensuring global payment, especially payment via cryptocurrency convenience and timeliness.

In another embodiment, to ensure high-quality task completion, the system introduces a smart-contract-based collateral guarantee and punishment mechanism. All participants must pay a certain amount of collateral cryptocurrency to the smart contract as a guarantee of work quality to prevent malicious behavior. The amount of collateral can be dynamically adjusted based on task complexity and workers' credit scores. The collateral funds are automatically escrowed by the smart contract to ensure their security and immutability.

In addition, platform participants must pledge a certain amount of funds to the smart contract as a work quality guarantee. In cases of malicious work behavior (such as uploading irrelevant data, random labeling, and verification), their pledged assets will be subject to system penalties.
S8: Updating users' credit scores based on the performance of workers from S5 to S7. Specifically, adjust the credit scores of workers and verifiers based on their work quality. Users with high credit scores will have more task opportunities, higher rewards, and may become reviewers. New users need to pass a collecting and labeling standard test (LST) to obtain corresponding identity certification. The system issues a DID (decentralized identity) to users who pass the test to identify their abilities and qualifications. Maintaining good work quality on a daily basis can also increase the level of DID.

In summary, the present disclosure reduces transaction costs by eliminating intermediary links, improves work efficiency, and ensures data consistency and quality through a BFT data consensus algorithm by using a BFT data consensus algorithm and a decentralized workflow engine (DWE), combined with a distributed task allocation mechanism and AI-assisted collection, labeling, and verification tools. This method not only enhances the overall efficiency of data collecting and labeling but also simplifies the reward payment process, especially payment via cryptocurrency through the automated payment process of smart contracts, thereby solving the problems of high cost, low efficiency, and poor quality control in existing technologies during data collecting and labeling.

Finally, it should be noted that the above embodiments are only preferred embodiments of the present disclosure and are not intended to limit the present disclosure. For those skilled in the art, modifications, equivalent replacements, improvements, etc., can be made to the above embodiments without departing from the spirit and scope of the present disclosure, and these should all be included within the scope of protection of the present disclosure.

What is claimed is:

1. A blockchain-smart-contract-driven decentralized AI training data collecting and labeling
method, comprising the following steps:
S1: deploying a decentralized workflow engine to a target blockchain, the workflow engine being used to manage distribution and validation of tasks;
S2: configuring roles and permissions based on the workflow engine deployed in S1, including but not limited to permissions of workers, verifiers, reviewers, and publishers;
S3: publishers creating tasks according to the role permissions configured in S2, uploading original datasets to be collected and labeled, setting requirements of collecting and labeling, and escrowing corresponding funds through a smart contract;
S4: a system automatically splitting the original datasets into multiple small tasks according to the tasks created in S3 and allocating the multiple small tasks to suitable workers based on the role configuration in S2;
S5: workers accepting tasks and performing data collecting and labeling according to the tasks allocated in S4;
S6: verifiers reviewing the collecting and labeling results submitted by workers in S5 and reaching data consistency through a BFT consensus algorithm;
S7: the system automatically executing a payment process through the smart contract based on the data consistency reached in S6.

2. The method according to claim 1, wherein the deployment of the workflow engine in S1 comprises establishing network, workflow, and blockchain layers, which communicate and coordinate with each other.

3. The method according to claim 1, wherein the role and permission configuration in S2 comprises permission management via RBAC.

4. The method according to claim 1, wherein when publishers create tasks in S3, they also set task types, detailed task descriptions, collecting/labeling specifications, and reward and incentive mechanism parameters.

5. The method according to claim 1, wherein the automatic task splitting and allocation in S4 also include data analysis and preprocessing, intelligent task splitting, and generation of unique task IDs.

6. The method according to claim 1, wherein when workers perform tasks in S5, they also use AI-assisted collecting and labeling tools.

7. The method according to claim 1, wherein the verification and review in S6 also comprises cross-verification and voting by multiple verifiers to reach BFT consensus and random spot checks.

8. The method according to claim 1, wherein the payment and settlement in S7 comprises supporting cryptocurrency and fiat payments and enabling inter-blockchain payments through cross-chain bridges.

9. The method according to claim 1, wherein the decentralized workflow engine is responsible for managing and scheduling functional components of user management, task management, API management, login/registration, role management, and payment management.

10. The method according to claim 1, wherein the smart contract runs on multiple chains to be executed across different blockchain networks.

11. The method according to claim 1 further comprises the following step after S7: S8: updating users' credit scores based on the performance of workers from S5 to S7.
